(19) United States
(12) Patent Application Publication
(10) Pub. No.: US 2010/0036923 A1
(43) Pub. Date: Feb. 11, 2010

(54) Methods and Systems for Dynamically Migrating Electronic Messages From A First Messaging Platform To A Second Messaging Platform

(76) Inventors: John C. Byrne, Stanhope, NJ (US); Richard H. Hoffman, JR., Point Pleasant, NJ (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/512,406

(22) Filed: Jul. 30, 2009

Related U.S. Application Data
(60) Provisional application No. 61/084,863, filed on Jul. 30, 2008.

(51) Int. Cl. G06F 15/16

(52) U.S. Cl. 709/206

(57) ABSTRACT

Methods and systems for dynamically migrating electronic messages from a first messaging platform to a second messaging platform are disclosed. In some embodiments, the methods and systems include the following: assigning a category to each electronic message from the first messaging platform; extracting messaging data from each of the electronic messages from the first messaging platform; collating the messaging data extracted; archiving the messaging data to generate archived messages; converting the messaging data to generate converted message data; transferring the converted message data to the second messaging platform; retrieving the electronic messages to generate shortcut collated data; locating the electronic message corresponding to the shortcut collated data; searching the electronic messages that were archived thereby generating a list of the electronic messages that meet the search criteria; converting messages to a format compatible with the second messaging platform; and transferring each of the electronic messages to the second messaging platform.

### CROSS REFERENCE TO RELATED APPLICATION(S)

This application claims the benefit of U.S. Provisional Application No. 61/084,863, filed Jul. 30, 2009, which is incorporated by reference as if disclosed herein in its entirety.

### BACKGROUND

Despite advances in migration technology, the conversion from a first messaging platform, e.g., Lotus Notes e-mail to a second messaging platform, e.g., Microsoft Exchange, continues to be both a costly and risky project for companies. Using current migration technology, users are often impacted because mailboxes are shut down during conversion, preventing access to e-mail, and messages are not fully or accurately converted, losing attachments, web links, links to applications and encryption.

Using current migration technology, information technology departments of companies are often impacted by the following problems: (1) because dual messaging systems have to be run for an extended period; (2) additional storage and servers have to be purchased to support the terabytes of converted e-mail now stressing the new messaging platform; (3) loss of data compression during the conversion process results in 1.2-1.5 times the volume of messages converted to the new messaging platform, requiring additional infrastructure; (4) problems during the e-mail conversion process mean that users cannot find specific e-mail generated in the first messaging platform or have lost key elements of a message, such as a link to a Domino application, and overload the company's Help Desk; and (5) decisions regarding the conversion of e-mail dependent applications related to the first messaging platform delay the migration project or force premature decisions.

The use of current migration technology often creates legal and compliance issues. For example, e-mail from the first messaging platform in its original mail format no longer exists and the fidelity of the converted message is not guaranteed. The loss of the original message and questionable fidelity make it difficult for general counsel and corporate compliance officers to comply with regulatory requirements that: (1) electronic documents must be produced in native format; and (2) with their metadata intact.

### SUMMARY

A system for dynamically migrating electronic messages from a first messaging platform to a second messaging platform is disclosed. Some embodiments of the system include the following: a message screening module for assigning a category to each of the electronic messages from the first messaging platform according to archiving rules; an extractor module for extracting messaging data from each of the electronic messages from the first messaging platform according to the category of each of the electronic messages; a data preparation module for collating the messaging data extracted from the electronic messages from the first messaging platform according to the category of each message to generate collated data; an archiving module for archiving the messaging data from each of the electronic messages from the first messaging platform to generate archived messages; a conversion module for converting the messaging data for each of the electronic messages from the first messaging platform categorized as archive and shortcut or archive and full message to a format compatible with the second messaging platform to generate converted message data, the converted message data retaining the messaging data for each of the archived messages; a transfer module for transferring the converted message data to the second messaging platform; and a message retrieval module for retrieving the electronic messages categorized as archive and shortcut or archive only from the archiving module.

A system for dynamically migrating electronic messages from a first messaging platform to a second messaging platform is disclosed. In some embodiments, the system includes the following: a message screening module for assigning a category to each of the electronic messages from the first messaging platform according to archiving rules; an extractor module for extracting messaging data from each of the electronic messages from the first messaging platform according to the category of each of the electronic messages; a data preparation module for collating the messaging data extracted from the electronic messages from the first messaging platform according to the category of each message to generate collated data; an archiving module for archiving the messaging data from each of the electronic messages from the first messaging platform to generate archived messages; a conversion module for converting the messaging data for each of the electronic messages from the first messaging platform categorized as archive and shortcut or archive and full message to a format compatible with the second messaging platform to generate converted message data, the converted message data retaining the messaging data for each of the archived messages; a transfer module for transferring the converted message data to the second messaging platform; and a message retrieval module for retrieving the electronic messages categorized as archive and shortcut or archive only from the archiving module.

A method of dynamically migrating electronic messages from a first messaging platform to a second messaging platform is disclosed. In some embodiments, the method includes the following: assigning a category to each of the electronic messages from the first messaging platform according to archiving rules, the category being one of archive only, archive and shortcut, and archive and full message; extracting messaging data from each of the electronic messages from the first messaging platform according to the category of each of the electronic messages; collating the messaging data extracted from the electronic messages from the first messaging platform according to the category of each message to generate collated data; archiving the messaging data from each of the electronic messages from the first messaging platform to generate archived messages; converting the messaging data for each of the electronic messages from the first messaging platform categorized as archive and shortcut or archive and full message to a format compatible with the second messaging platform to generate converted message data; transferring the converted message data to the second messaging platform; retrieving the electronic messages categorized as archive and shortcut by searching the collated data according to shortcut identifying data to generate shortcut collated data; locating the electronic message corresponding to the shortcut collated data; searching the electronic messages that were archived by searching the collated data according to a search criteria thereby generating a list of the electronic messages that meet the search criteria; converting messages corresponding to the shortcut collated data or selected messages from the list of the electronic messages that meet the search criteria to a format compatible with the second messaging platform; and transferring each of the electronic messages that were converted and correspond to the shortcut collated data or selected messages from the list of the electronic messages that meet the search criteria to the second messaging platform.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of a system according to some embodiments of the disclosed subject matter;

FIG. 2 is a diagram of a system according to some embodiments of the disclosed subject matter;

FIG. 3 is a diagram of a system according to some embodiments of the disclosed subject matter;

FIGS. 4A-4C are diagrams of a system according to some embodiments of the disclosed subject matter;

FIG. 5 is a diagram of a system according to some embodiments of the disclosed subject matter; and

FIG. 6 is a schematic diagram of a system according to some embodiments of the disclosed subject matter.

### DETAILED DESCRIPTION

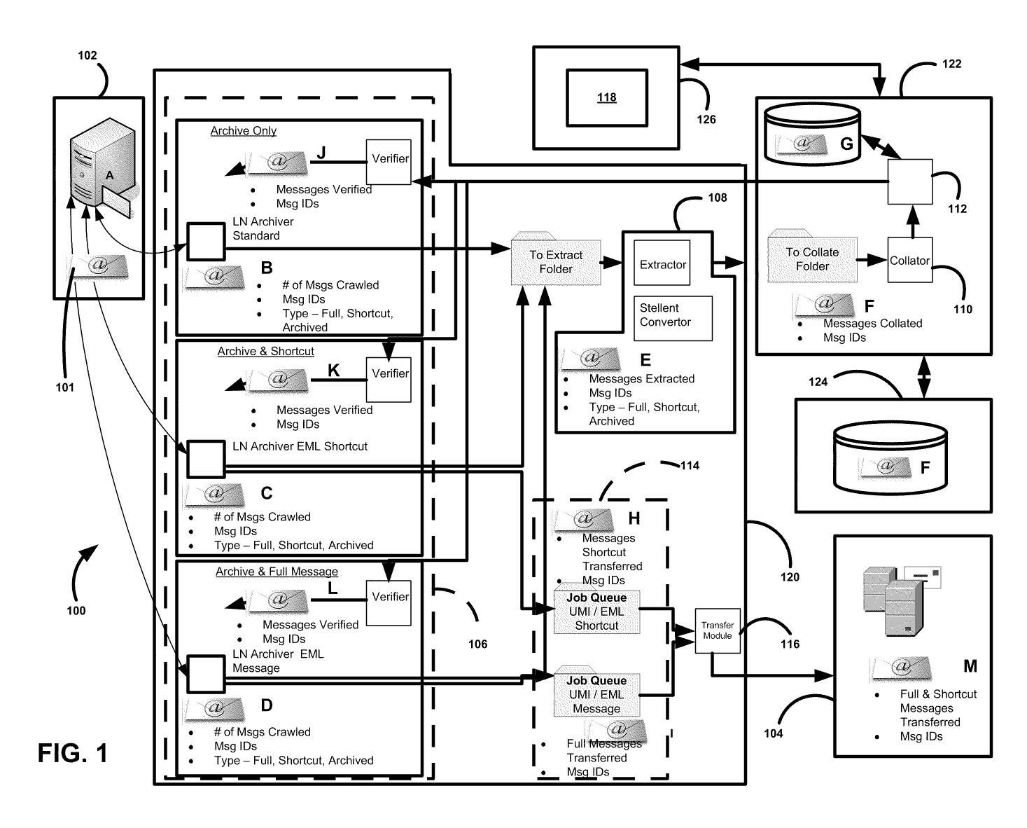

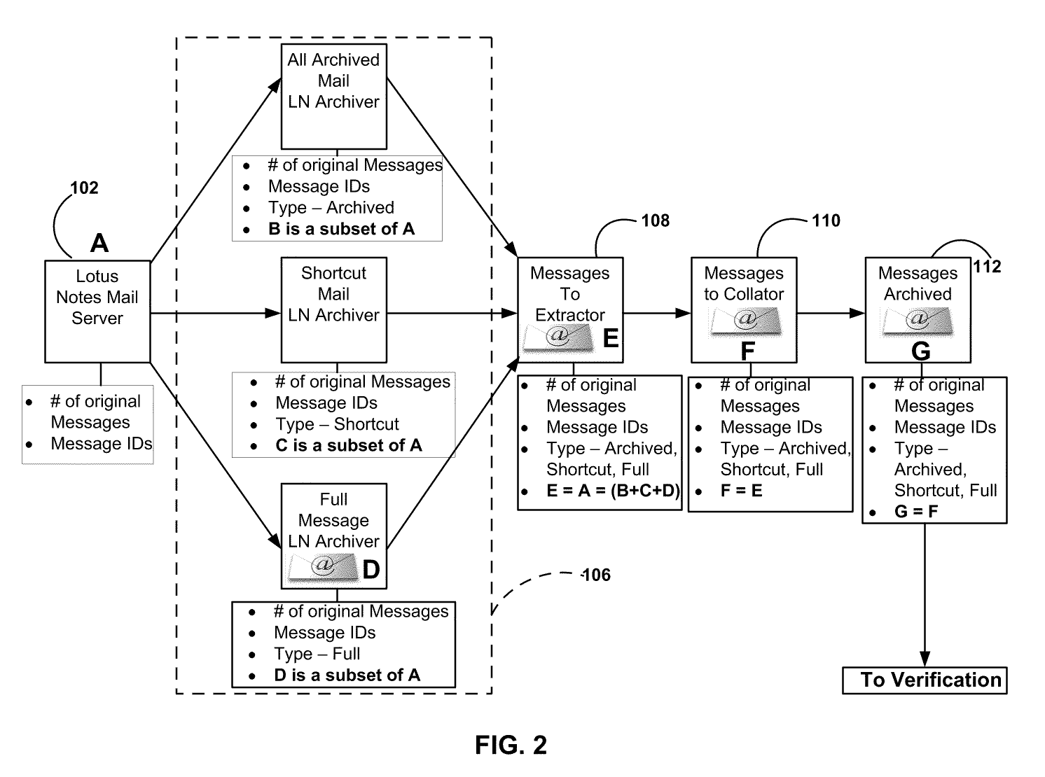

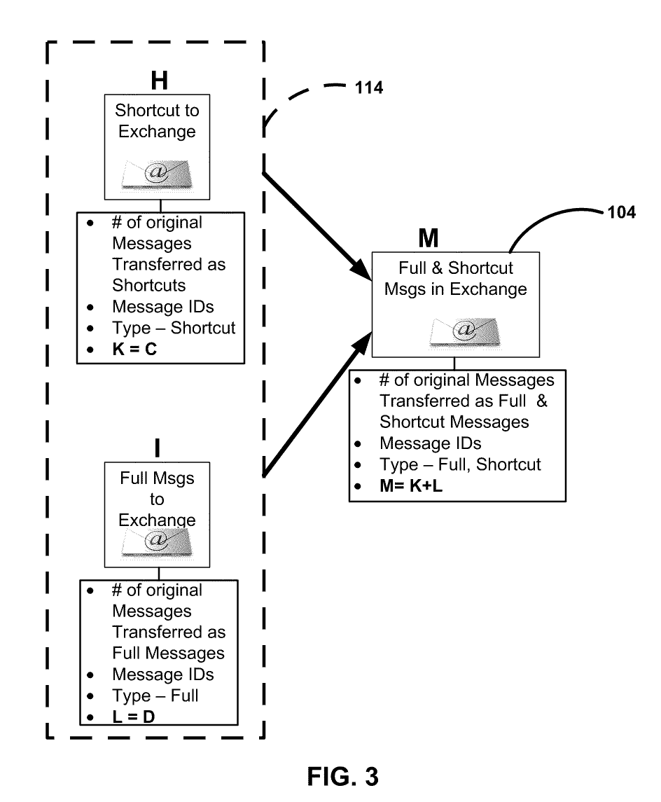

Referring now to the drawings in which like reference numerals indicate like parts, and in particular, to FIGS. 1-6, some embodiments of the disclosed subject matter include a system 100 for dynamically migrating electronic messages 101 or other data from a first messaging platform 102, e.g., Lotus Notes or Microsoft Exchange, to a second messaging platform 104, e.g., Microsoft Exchange or Lotus Notes. As shown in FIG. 1, system 100 has a plurality of cooperating modules, including a message screening module 106, an extractor module 108, a data preparation module 110, an archiving module 112, a conversion module 114, a transfer module 116, and a message retrieval module 118, which are located on a plurality of servers that are positioned between first messaging platform 102 and second messaging platform 104.

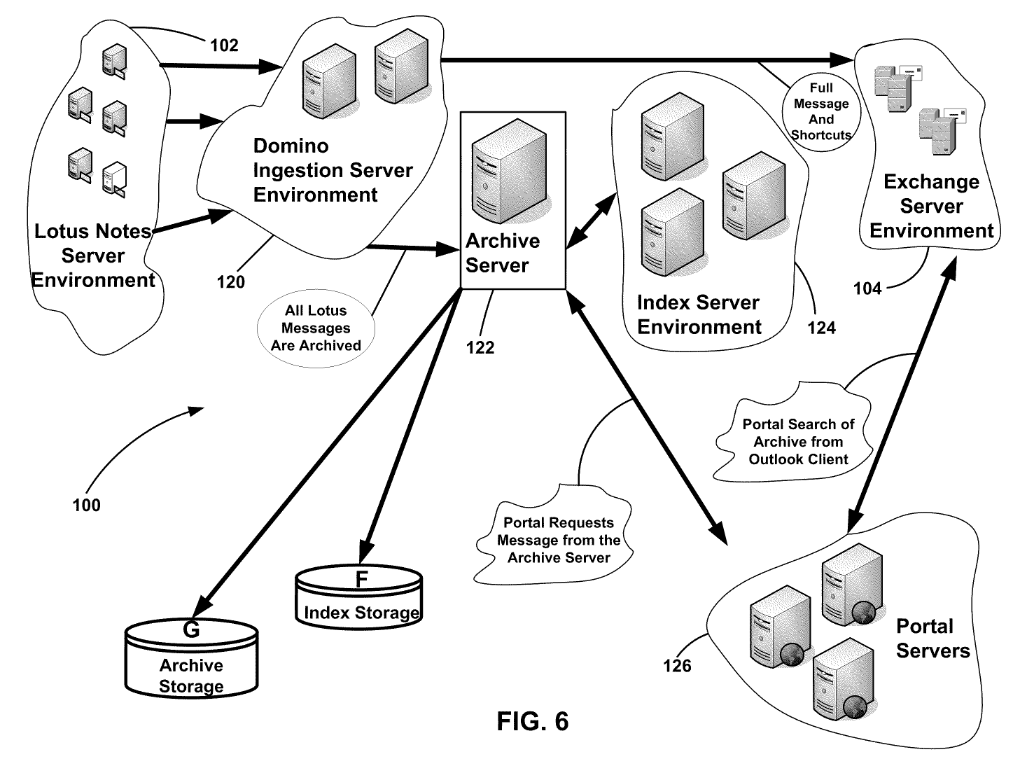

Message screening module 106 includes methods for assigning a category B, C, D to each of electronic messages 101 from first messaging platform 102 according to predetermined archiving rules (not shown). Category B is defined as archive only, category C is defined as archive and shortcut, and category D is defined as archive and full message. As shown in FIG. 6, message screening module 106 is located on an ingestion server 120.

Extractor module 108 includes methods for extracting messaging data E from each of electronic messages 101 from first messaging platform 102 according to the assigned category, i.e., category B, C, or D, of each of the electronic messages. Extractor module 108 is positioned on ingestion server 120.

Data preparation module 110 includes methods for collating messaging data E extracted from electronic messages 101 from first messaging platform 102 according to the assigned category of each message to generate collated data F. Data preparation module 110 is positioned on an archive server 122 and collated data F is stored on an index server 124 that is in communication with the archive server.

Archiving module 112 includes methods for archiving messaging data E from each of electronic messages 101 from first messaging platform 102 to generate archived messages G. Archiving module 112 is positioned on archive server 122 and archived messages G are accessible via the archive server.

Conversion module 114 includes methods for converting messaging data E for each of electronic messages 101 from first messaging platform 102 that are categorized as archive and shortcut or archive and full message to a format compatible with second messaging platform 104 to generate converted message data H and I. Conversion module is positioned on ingestion server 120.

Transfer module 116 includes methods for transferring converted message data H and I to second messaging platform 104 (shown as converted message data M in FIG. 1). Transfer module 116 is positioned on ingestion server 120.

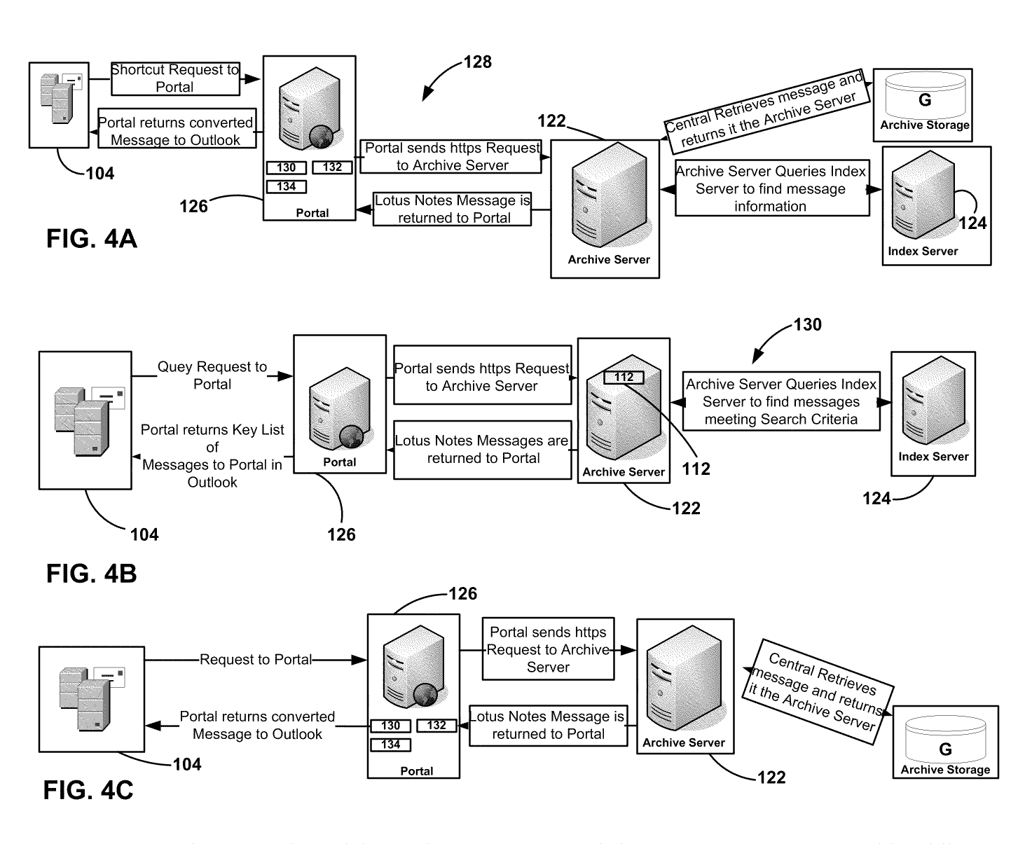

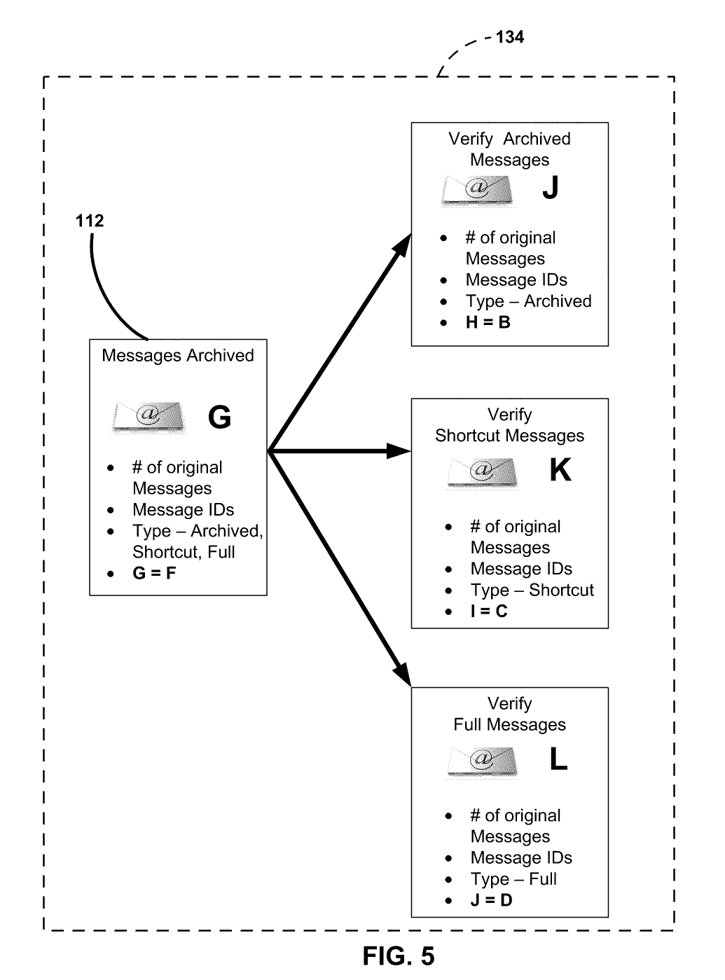

Message retrieval module 118 includes methods for retrieving electronic messages 101 that are categorized as archive and shortcut or archive only from archiving module 112. Message retrieval module 118 is positioned on a portal server 126. Referring also to FIGS. 4A-4C, message retrieval module 118 includes the following cooperating sub-modules: a shortcut retrieval sub-module 128; a message query sub-module 130; a conversion sub-module 132; and a transfer sub-module 134. Additional disclosure with respect to message retrieval module 118 is provided on FIGS. 4A-4D and FIG. 5.

Referring now to FIGS. 4A-4D, shortcut retrieval sub-module 128 includes methods for retrieving electronic messages 101 categorized as archive and shortcut by searching collated data F stored on index server 124 according to shortcut identifying data (not shown) to generate shortcut collated data (not shown), locating the electronic message corresponding to the shortcut collated data on archive server 122, and sending the electronic messages corresponding to the shortcut collated data to conversion sub-module 132, which is located in message retrieval module 118 on portal server 126.

Message query sub-module 130, which is part of message retrieval module 118 on portal server 126, includes methods for searching archived messages G on archiving module 112 by searching collated data F stored on index server 124 according to a search criteria thereby generating a list (not shown) of the archived messages that meet the search criteria. Message query sub-module 130 includes methods to display a rendering of the message in HTML format, such format being more suitable for previewing the message, and also for personal communication devices such as hand held email communication systems.

Conversion sub-module 132 includes methods for converting the electronic messages retrieved in shortcut retrieval sub-module 128 or selected messages from the list of electronic messages that meet search criteria that is generated in message query sub-module 130 to a format compatible with second messaging platform 104.

Transfer sub-module 134 includes methods for transferring each of the electronic messages converted in conversion sub-module 132 to second messaging platform 104. As shown in FIGS. 1 and 5, each of the electronic messages converted in conversion sub-module 132 to second messaging platform 104 is verified to generate verified and converted messages J, K, and L, before transferring to second messaging platform 104.

The present invention offers advantages over known methods and systems. Methods and systems of the disclosed subject matter provide end users with immediate, secure access to their legacy e-mail directly, without requiring the usual bulk conversion of e-mail. Original records remain unchanged and are retained with full fidelity. If and when messages are required in the new messaging environment, i.e., second messaging platform, e.g., in order to reply to an e-mail, for instance, the message is dynamically converted to the second messaging platform format, e.g., Exchange or Notes, along with any attachments, links to applications, encryption (with available keys) and web links. This streamlined approach also avoids having to lock in decisions regarding the conversion of related applications, e.g., Domino applications, allowing a planned, incremental, and dynamic conversion process.

As described herein, embodiments of the disclosed subject matter are presented as methods and systems for dynamically migrating electronic messages from a first messaging platform to a second messaging platform. In addition, by way of example, the first messaging platform is presented as Lotus Notes and the second messaging platform is presented as Microsoft Exchange. Other embodiments of the disclosed subject matter, which are fully contemplated and supported by the above description, include methods and systems for dynamically migrating other types of data from a first data platform to a second data platform. In still other embodiments of the disclosed subject matter, the first and second messaging platforms can be ones other than Lotus Notes and Microsoft Exchange.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. A system for dynamically migrating electronic messages from a first messaging platform to a second messaging platform, said system comprising:
a message screening module for assigning a category to each of said electronic messages from said first messaging platform according to archiving rules;
an extractor module for extracting messaging data from each of said electronic messages from said first messaging platform according to said category of each of said electronic messages;
a data preparation module for collating said messaging data extracted from said electronic messages from said first messaging platform according to said category of each message to generate collated data;
an archiving module for archiving said messaging data from each of said electronic messages from said first messaging platform to generate archived messages;
a conversion module for converting said messaging data for each of said electronic messages from said first messaging platform categorized as archive and shortcut or archive and full message to a format compatible with said second messaging platform to generate converted message data, said converted message data retaining said messaging data for each of said archived messages;
a transfer module for transferring said converted message data to said second messaging platform; and
a message retrieval module for retrieving said electronic messages categorized as archive and shortcut or archive only from said archiving module.

2. A system according to claim 1, wherein said category is one of archive only, archive and shortcut, and archive and full message.

3. A system according to claim 1, wherein said message screening module is positioned on an ingestion server, said extractor module is positioned on said ingestion server, said conversion module is positioned on said ingestion server, said data preparation module is positioned on an archive server, said collated data is stored on an index server that is in communication with said archive server, said archiving module is positioned on said archive server, said archived messages are accessible via said archive server, and said message retrieval module is positioned on a portal server.

4. A system according to claim 1, wherein said message retrieval module further comprises the following sub-modules:
a shortcut retrieval sub-module for retrieving said electronic messages categorized as archive and shortcut by searching said collated data stored on said index server according to shortcut identifying data to generate shortcut collated data, locating said electronic message corresponding to said shortcut collated data on said archive server, and sending said electronic messages corresponding to said shortcut collated data to a conversion sub-module positioned on said portal server;
a message query sub-module for searching said electronic messages archived in said archiving module by searching said collated data stored on said index server according to a search criteria thereby generating a list of said electronic messages that meet said search criteria;
a conversion sub-module for converting messages retrieved in said shortcut retrieval sub-module or selected messages from said list of said electronic messages that meet said search criteria that is generated in said message query sub-module to a format compatible with said second messaging platform;
a transfer sub-module for transferring each of said electronic messages converted in said conversion sub-module to said second messaging platform, said transfer sub-module being positioned on said portal server; and
a display sub-module for converting said electronic messages into HTML format.

5. A system according to claim 1, wherein said first messaging platform is one of Lotus Notes or Microsoft Exchange.

6. A system according to claim 5, wherein if said first messaging platform is said Lotus Notes, said second messaging platform is Microsoft Exchange.

7. A system according to claim 5, wherein if said first messaging platform is said Microsoft Exchange, said second messaging platform is Lotus Notes.

8. A system for dynamically migrating electronic messages from a first messaging platform to a second messaging platform, said system comprising:
a message screening module for assigning a category to each of said electronic messages from said first messaging platform according to archiving rules;
an extractor module for extracting messaging data from each of said electronic messages from said first messaging platform according to said category of each of said electronic messages;
a data preparation module for collating said messaging data extracted from said electronic messages from said first messaging platform according to said category of each message to generate collated data;
an archiving module for archiving said messaging data from each of said electronic messages from said first messaging platform to generate archived messages;
a conversion module for converting said messaging data for each of said electronic messages from said first messaging platform categorized as archive and shortcut or archive and full message to a format compatible with said second messaging platform to generate converted message data, said converted message data retaining said messaging data for each of said archived messages;
a transfer module for transferring said converted message data to said second messaging platform; and
a message retrieval module for retrieving said electronic messages categorized as archive and shortcut or archive only from said archiving module.

9. A system according to claim 1, wherein said category is one of archive only, archive and shortcut, and archive and full message.

10. A system according to claim 1, wherein said message retrieval module further comprises the following sub-modules:
a shortcut retrieval sub-module for retrieving said electronic messages categorized as archive and shortcut by searching said collated data according to shortcut identifying data to generate shortcut collated data, locating said electronic message corresponding to said shortcut collated data, and sending said electronic messages corresponding to said shortcut collated data to a conversion sub-module;
a message query sub-module for searching said electronic messages archived in said archiving module by searching said collated data stored according to a search criteria thereby generating a list of said electronic messages that meet said search criteria;
a conversion sub-module for converting messages retrieved in said shortcut retrieval sub-module or selected messages from said list of said electronic messages that meet said search criteria that is generated in said message query sub-module to a format compatible with said second messaging platform;
a transfer sub-module for transferring each of said electronic messages converted in said conversion sub-module to said second messaging platform; and
a display sub-module for converting said electronic messages into HTML format.

11. A system according to claim 1, wherein said first messaging platform is one of Lotus Notes or Microsoft Exchange.

12. A system according to claim 5, wherein if said first messaging platform is said Lotus Notes, said second messaging platform is Microsoft Exchange.

13. A system according to claim 5, wherein if said first messaging platform is said Microsoft Exchange, said second messaging platform is Lotus Notes.

14. A method of dynamically migrating electronic messages from a first messaging platform to a second messaging platform, said method comprising:
assigning a category to each of said electronic messages from said first messaging platform according to archiving rules, said category being one of archive only, archive and shortcut, and archive and full message;
extracting messaging data from each of said electronic messages from said first messaging platform according to said category of each of said electronic messages;
collating said messaging data extracted from said electronic messages from said first messaging platform according to said category of each message to generate collated data;
archiving said messaging data from each of said electronic messages from said first messaging platform to generate archived messages;
converting said messaging data for each of said electronic messages from said first messaging platform categorized as archive and shortcut or archive and full message to a format compatible with said second messaging platform to generate converted message data;
transferring said converted message data to said second messaging platform;
retrieving said electronic messages categorized as archive and shortcut by searching said collated data according to shortcut identifying data to generate shortcut collated data;
locating said electronic message corresponding to said shortcut collated data;
searching said electronic messages that were archived by searching said collated data according to a search criteria thereby generating a list of said electronic messages that meet said search criteria;
converting messages corresponding to said shortcut collated data or selected messages from said list of said electronic messages that meet said search criteria to a format compatible with said second messaging platform; and
transferring each of said electronic messages that were converted and correspond to said shortcut collated data or selected messages from said list of said electronic messages that meet said search criteria to said second messaging platform.

15. A method according to claim 14, wherein said first messaging platform is one of Lotus Notes or Microsoft Exchange.

16. A method according to claim 14, wherein if said first messaging platform is said Lotus Notes, said second messaging platform is Microsoft Exchange.

17. A method according to claim 14, wherein if said first messaging platform is said Microsoft Exchange, said second messaging platform is Lotus Notes.
